(19) United States
(12) Patent Application Publication
(10) Pub. No.: US 2026/0102708 A1
(43) Pub. Date: Apr. 16, 2026

(54) GAME DESIGNER GUARDRAILED PROCEDURAL CONTENT GENERATION FOR GAMES

(71) Applicant: Sony Interactive Entertainment Inc., Tokyo (JP)

(72) Inventors: Michael Padilla, San Mateo, CA (US); Jin Zhang, San Mateo, CA (US); Richard Solano, San Mateo, CA (US)

(21) Appl. No.: 18/915,944

(22) Filed: Oct. 15, 2024

(51) Int. Cl. A63F 13/60; G06N 3/094

(52) U.S. Cl. CPC A63F 13/60; G06N 3/094; A63F 2300/6009

(57) ABSTRACT

Techniques are provided to limit/guardrail computer simulation content generation by a generative model (GM) by providing key frames of the simulation to the GM to interpolate between to thereby provide content guidelines (location, style, etc.) as well as duration of content to be generated by the GM.

### FIELD

The present application relates generally to using generative models (GM) to generate content for computer simulations such as computer games, and more particularly to providing guardrails to a GM to limit the scope and duration of content generated by the GM so as to ensure that the GM does not generate content too far afield from the spirit of the simulation.

### BACKGROUND

GMs can be used to generate content. As understood herein, techniques may be provided to train GMs to generate content for computer simulations such as computer games.

### SUMMARY

As further recognized herein, while GMs can be leveraged to efficiently produce content for computer games, it is desirable that the GMs not stray too far afield by generating content that may unduly depart from the style and spirit of the games.

Accordingly, an apparatus includes at least one processor system configured to input plural author-generated keyframes of a computer simulation to at least one generative model (GM) and receive from the GM an output of computer simulation frames between the keyframes. The processor system is configured to present the output of the GM on at least one display as a computer simulation. The computer simulation can be a computer game.

In some examples, at least some of the keyframes define one or more of lighting constraining output of the GM, style constraining output of the GM, objects constraining output of the GM, and time periods constraining output of the GM.

In example implementations at least a first one of the keyframes is constructed by a designer and is not part of an existing computer simulation. In other implementations at least a first one of the keyframes is obtained from an existing computer simulation. Such a keyframe can be selected based on the first keyframe being at an endpoint of a game step in an existing computer simulation, or based on the first keyframe being after a cut scene in an existing computer simulation, or based on the first keyframe exhibiting a predetermined type of action.

In another aspect, a device includes computer memory that is not a transitory signal and that in turn includes instructions executable by at least one processor system to input plural keyframes to a generative model (GM). Each keyframe includes at least one parameter. The GM is trained to output at least one video clip constrained by the parameter. The instructions are executable to receive a video clip from the GM responsive to input of the keyframes, and play the video clip as a computer game.

In another aspect, a method includes inputting keyframes to a machine learning (ML) model, and generating a computer game based on output of the ML model that is in consonance with the keyframes.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a combined software and hardware block diagram of an example architecture;

FIG. 3 illustrates example overall logic in example flow chart format;

FIG. 4 illustrates a screen shot of an example user interface (UI) for selecting keyframe parameters;

FIG. 5 illustrates a screen shot of an example UI for creating a keyframe;

FIG. 6 illustrates a screen shot of an example UI for editing a keyframe;

FIG. 7 illustrates example logic in example flow chart format for creating a computer simulation;

FIG. 8 illustrates example logic in example flow chart format for training the computer simulation creation GM shown in FIG. 2

FIG. 9 illustrates example logic in example flow chart format for training the artificial intelligence (AI) editor shown in FIG. 2; and

FIG. 10 illustrates example logic in example flow chart format for an alternate keyframe selection technique.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

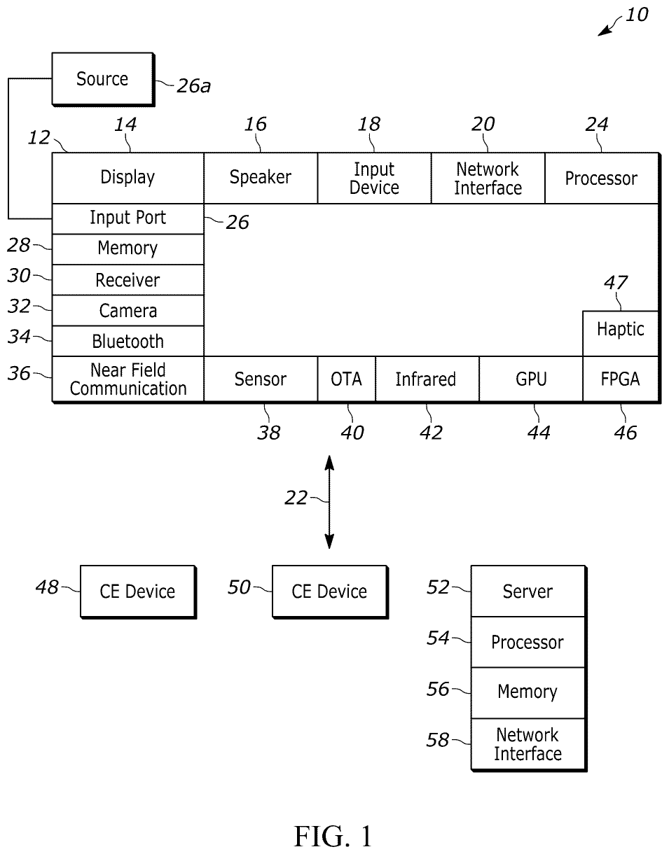

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative models such as large language models/pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

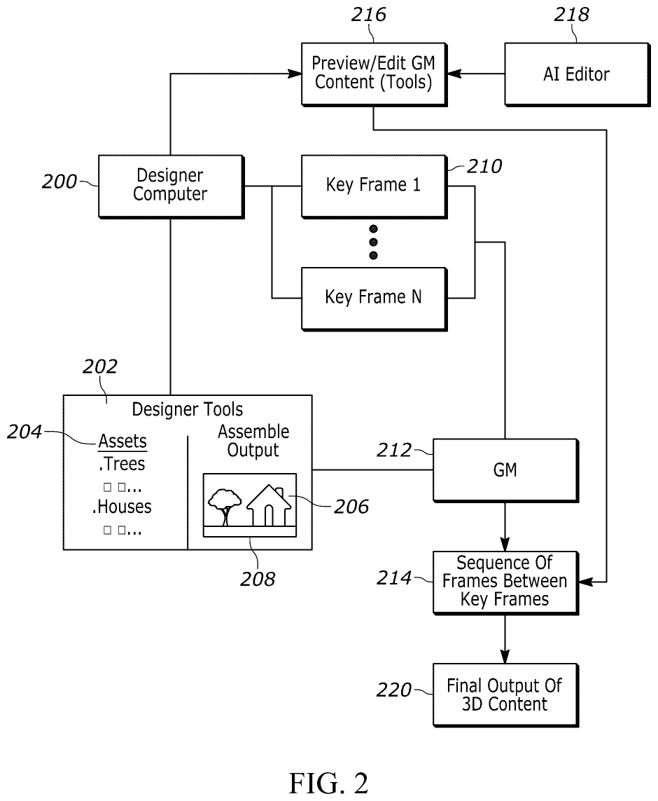

Refer now to FIG. 2. A designer computer 200 operated by a designer of computer simulations such as computer games can access designer tools 202 to design computer simulation video such as one or more video scenes in a three dimensional (3D) computer game using machine learning (ML) constrained in its video generation by periodic key video frames (“keyframes”). In FIG. 2, the designer tools include selection of assets 204 such as trees and structures that can be assembled into an output 206 by, e.g., dragging and dropping assets into an output window 208. This is one method for generating keyframes 210 to define guardrails for the video scene to be generated by a ML model 212 such as a generative model (GM) into a sequence of video frames 214 between the keyframes 210, reverting to the bracketing keyframes as anchors between which the GM-generated sequences 214 are interpolated.

Note that in addition to assets, the designer tools 202 may include selectors for defining lighting constraining output of the GM. For example, the designer may be able to impose constraints on the GM that the video it generates should exhibit darker scenes or lighter scenes. Moreover, the designer tools 202 may include selectors for defining style constraining output of the GM. For example, the designer may define an artistic style to be baroque in tone, or classical in tone, or cartoon style video, or movie style video. Yet again, the designer may define video action style to be violent, or non-violent, or mellow, or frenetic, or passive, or aggressive as indicated by, e.g., player gaming style on the fly, or other action-type styles. The keyframes further may define or limit time periods between keyframes for which the GM is to generate video.

Still further, the keyframe parameters may also include color theme such as a requirement to use primary colors, or to use pastels, or warm colors, or cool colors.

The designer computer 200 also may access video edit tools 216 to edit the initial output of the GM. In addition or alternatively, an artificial intelligence (AI) editor 218 may employ editing tools 216 to edit the output of the GM. The AI editor may perform image recognition to analyze objects and placement and lighting to ascertain whether the GM output is acceptable given the constraints of the keyframes.

A final computer simulation output 220 is generated after editing and presented for interactive play using, e.g., a computer game controller.

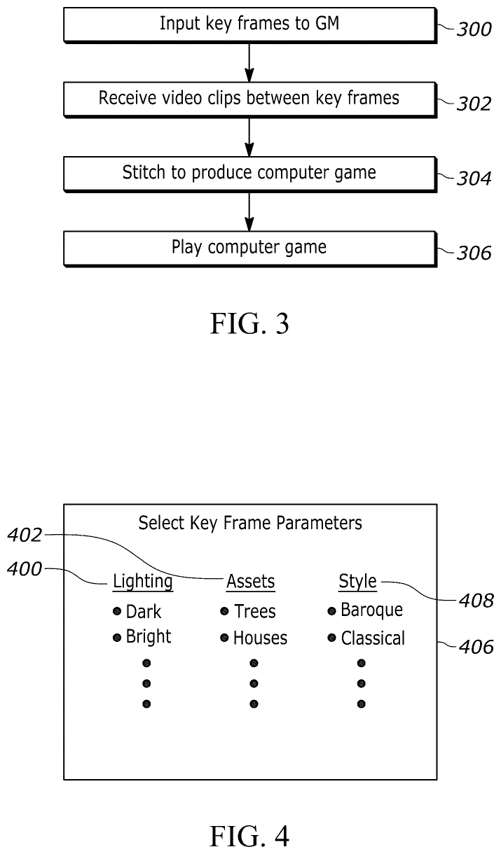

FIG. 3 illustrates example logic. Commencing at state 300, keyframes generated using any of the techniques described herein are input to the GM. In response, at state 302 video clips between the keyframes are received back from the GM and, after editing, stitched together at state 304 to produce a complete computer game. The computer game may be presented on a display for play at state 306.

FIG. 4 illustrates further details of the designer tools discussed above. Keyframe parameters such as lighting 400, assets 402, and style 404 may be presented on a display 406 such as any display herein for a designer to construct a keyframe using the parameters.

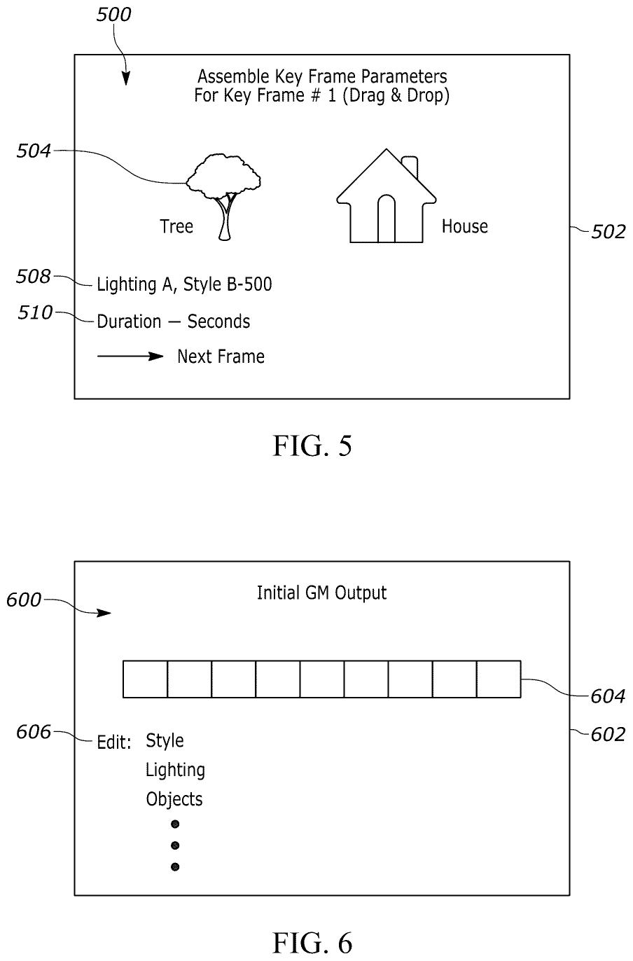

FIG. 5 illustrates that the parameters from FIG. 4 may be assembled into a frame 500 presented on a display 502 such as any display described herein. The frame 500 includes selected assets 504 presented in a selected style 506 with selected lighting 508. The frame 500 may define a period 510 for which video is to be generated by the GM following the frame 500. A next frame selector 512 may be provided to allow the designer to assemble another keyframe following the keyframe 500.

FIG. 6 illustrates an edit screen 600 that may be presented on a display 602 such as any display herein for a designer to edit an initial video output 604 (depicted as a sequence of frames) from the GM. The screen 600 may prompt 606 the designer to edit style, objects, lighting, etc. as the designer sees fit from the initial output 604 to produce a final clip.

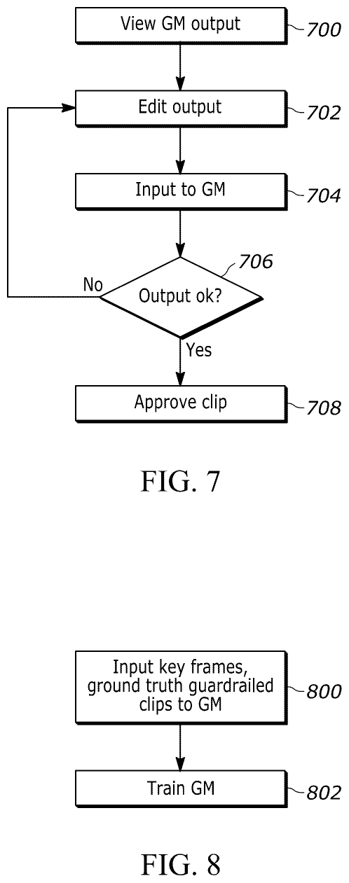

FIG. 7 illustrates the above principles in flow chart format. Commencing at state 700 the initial output of the GM is viewed and if desired edited at state 702. The edited clip may be input back to the GM at state 704, which produces another output. If the ensuing output is determined at state 706 (programmatically by the AI editor or by a human designer) not to be satisfactory (i.e., not in consonance with the keyframes), it is re-edited at state 702 for another iteration; otherwise, if the output is satisfactory, it is indicated as being approved for inclusion in the computer game at state 708.

FIG. 8 illustrates a technique for training the GM 212 in FIG. 2. At state 800 a training set of keyframes is input to the GM to train the GM a state 802. The training set may include keyframes along with “guardrailed” clips, i.e., examples of acceptable video clips conforming to the constraints of the keyframes.

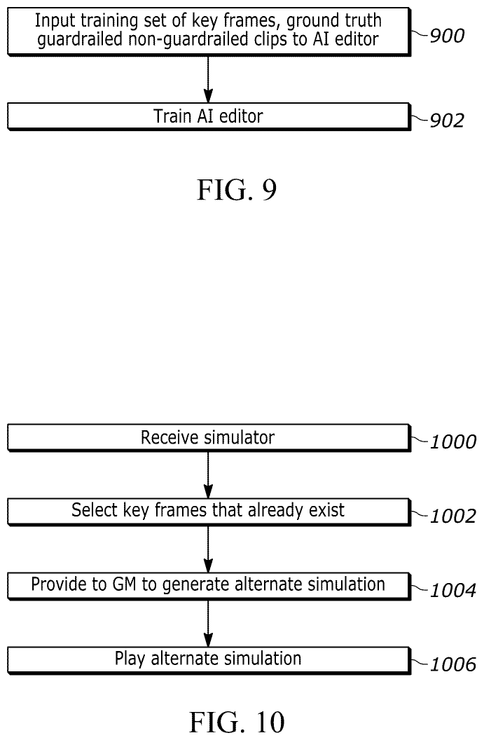

FIG. 9 illustrates a technique for training the AI editor 218 in FIG. 2. At state 900 a training set of data is input to the AI editor to train the AI editor a state 902. The training set may include keyframes with ground truth acceptable and unacceptable clips associated with the keyframes.

FIG. 10 illustrates an alternate technique for obtaining keyframes for input to the GM to guardrail or constrain the GM. An existing computer simulation may be received at state 1000. Moving to state 1002, keyframes from the simulation that already exists can be selected. Then, at state 1004 the keyframes can be provided to the GM so that the GM generates an alternate simulation which may be presented and played at state 1006.

In yet another technique, keyframes may be selected to be input to a GM offline or in real time on the basis that the keyframes are endpoints of game “steps”, not tied to time but to game space. The keyframes in this technique thus are task-based. Keyframes beginning after cut scenes also can be used. Further, keyframes exhibiting a certain type of action such as shooting may be identified as suitable for input to the GM to generate further video.

While the particular embodiments are herein shown and described in detail, it is to be understood that the subject matter which is encompassed by the present invention is limited only by the claims.

What is claimed is:

1. An apparatus comprising:
at least one processor system configured to:
input plural author-generated keyframes of a computer simulation to at least one generative model (GM);
receive from the GM an output of computer simulation frames between the keyframes; and
present the output of the GM on at least one display as a computer simulation.

2. The apparatus of claim 1, wherein the computer simulation comprises a computer game.

3. The apparatus of claim 1, wherein at least some of the keyframes define lighting constraining output of the GM.

4. The apparatus of claim 1, wherein at least some of the keyframes define style constraining output of the GM.

5. The apparatus of claim 1, wherein at least some of the keyframes define objects constraining output of the GM.

6. The apparatus of claim 1, wherein at least some of the keyframes define time periods constraining output of the GM.

7. The apparatus of claim 1, wherein at least a first one of the keyframes is constructed by a designer and is not part of an existing computer simulation.

8. The apparatus of claim 1, wherein at least a first one of the keyframes is obtained from an existing computer simulation.

9. The apparatus of claim 1, wherein at least a first one of the keyframes is selected based on the first keyframe being at an endpoint of a game step in an existing computer simulation.

10. The apparatus of claim 1, wherein at least a first one of the keyframes is selected based on the first keyframe being after a cut scene in an existing computer simulation.

11. The apparatus of claim 1, wherein at least a first one of the keyframes is selected based on the first keyframe exhibiting a predetermined type of action.

12. A device comprising:
computer memory that is not a transitory signal and that comprises instructions executable by at least one processor system to:
input plural keyframes to a generative model (GM), each keyframe comprising at least one parameter, the GM being trained to output at least one video clip constrained by the parameter;
receive a video clip from the GM responsive to input of the keyframes; and
play the video clip as a computer game.

13. The device of claim 12, wherein at least one of the keyframes is generated and is not part of an existing computer game.

14. The device of claim 12, wherein at least one of the keyframes is selected from an existing computer game.

15. The device of claim 12, wherein the instructions are executable to reject the video clip responsive to the video clip not being in consonance with the keyframes.

16. The device of claim 12, wherein the parameters comprises one or more of a video object, a color scheme.

17. The device of claim 12, wherein the parameters comprises one or more of a video object, a style.

18. A method comprising:
inputting keyframes to a machine learning (ML) model; and
generating a computer game based on output of the ML model that is in consonance with the keyframes.

19. The method of claim 18, comprising determining whether the output of the ML model is consonance with the keyframes based at least in part on one or more parameters of the keyframes.
